(19) United States
(12) Patent Application Publication
(10) Pub. No.: US 2012/0327086 A1
(43) Pub. Date: Dec. 27, 2012

(54) IMAGE PROCESSING APPARATUS AND IMAGE PROCESSING METHOD

(75) Inventor: Susumu Shimbaru, Yokohama-shi (JP)

(73) Assignee: CANON KABUSHIKI KAISHA, Tokyo (JP)

(21) Appl. No.: 13/582,099

(22) PCT Filed: Apr. 27, 2011
(86) PCT No.: PCT/JP2011/060691

§ 371 Date: Aug. 31, 2012

(30) Foreign Application Priority Data
May 24, 2010 (JP) 2010-118769

(51) Int. Cl. G06T 1/00; G06T 15/20

(52) U.S. Cl. 345/427; 345/501

(57) ABSTRACT

Tristimulus values of a partial adaptation white point of a virtual object and those of a partial adaptation white point of a display device are calculated from tristimulus values of a white point of the display device, and those of a white point of the virtual object, which are decided according to the area of a light source central reflection region. Then, RGB values for respective pixel positions on a projection plane are settled based on these partial adaptation white points, and a rendering image configured by pixels having the RGB values is formed on the projection plane.

### TECHNICAL FIELD

The present invention relates to an image display technique.

### BACKGROUND ART

Conventionally, as a method of simulating appearance of an object using an output device such as a display, a method of pseudo three-dimensionally displaying a three-dimensional (3D) shape on a two-dimensional (2D) screen using a 3D computer graphics (3D-CG) technique is known. Using the 3D-CG technique, the appearances of an object from various viewpoints can be simulated by rotating, enlarging, and reducing the object.

In the 3D-CG technique, optical information such as a reflectance, radiance, refractive index, or transmittance is set for an object such as a 3D object or light source, and physical colors to be displayed are calculated based on tristimulus values (for example, XYZ values). Thus, the physical colors to be displayed can be accurately calculated, but they have to be compressed so as to be reproduced as faithfully as possible according to a color reproduction range of an output device.

For example, Japanese Patent Laid-Open No. 2000-009537 discloses a method which expresses a spectrum of reflected light by a linear sum of diffuse and specular reflection components using a dichroic reflection model. With this method, the diffuse and specular reflection components are respectively multiplied by predetermined constants or functions to adjust the reflected light spectrum to fall within the color reproduction range of the output device. However, since this method does not consider any human adaptation state, the simulation result does not necessarily match human subjective perception.

Japanese Patent Laid-Open No. 2008-146260 discloses a method of generating a satisfactory image based on the adaptation state of human vision by setting appearance parameters for respective objects, so that a rendering image can match human subjective perception.

However, since human visual characteristics adapt to an object having a higher luminance level, when an object has a glossy surface, the adaptation state of human vision changes depending on the presence/absence of reflection of a light source due to specular reflection. If no reflection of the light source is present, human vision adapts to a highest luminance point of diffuse reflection components. However, if reflection is present, human vision tends to adapt to specular reflection components having a higher luminance level. These related arts do not consider any temporal change in adaptation state which occurs upon viewing of a single object, resulting in different actual appearances of the object.

### SUMMARY OF INVENTION

The present invention has been made in consideration of the aforementioned problems, and provides a technique for determining a reflection state of a light source onto an object, and generating an output image using adaptation white points calculated according to the determination result.

According to one aspect of the present invention, there is provided an image processing apparatus comprising: a first acquisition unit configured to acquire information of an object and information of a light source, which are laid out on a virtual space; a second acquisition unit configured to acquire a viewing condition required to view the object; a first decision unit configured to decide a state of reflection of the light source on the object upon viewing the object based on the viewing condition; and a second decision unit configured to decide an adaptation white point upon displaying the object by an image output unit, based on the state of reflection.

According to another aspect of the present invention, there is provided an image processing method comprising: a first acquisition step of acquiring information of an object and information of a light source, which are laid out on a virtual space; a second acquisition step of acquiring a viewing condition required to view the object; a first decision step of deciding a state of reflection of the light source on the object upon viewing the object based on the viewing condition; and a second decision step of deciding an adaptation white point upon displaying the object by an image output unit, based on the state of reflection.

Further features of the present invention will become apparent from the following description of exemplary embodiments with reference to the attached drawings.

### BRIEF DESCRIPTION OF DRAWINGS

FIG. 1 is a block diagram showing an example of the functional arrangement of an image processing apparatus 1 and its peripheral devices;

FIG. 2 is a flowchart of processing executed by the image processing apparatus 1;

FIG. 3 is a view showing an example of a virtual object;

FIG. 4 is a view for explaining BRDF characteristics;

FIG. 5 is a view showing an example of a virtual space upon generation of a rendering image;

FIGS. 6A and 6B are views showing examples of different thresholds m for different BRDF characteristics;

FIG. 7 is a view showing an example of a device profile of an image output device 2;

FIG. 8 is a block diagram showing an example of the functional arrangement of an image processing apparatus 81 and its peripheral devices;

FIG. 9 is a flowchart of processing executed by the image processing apparatus 81; and

FIG. 10 is a conceptual graph of the relationships among white points.

### DESCRIPTION OF EMBODIMENTS

Embodiments of the present invention will be described hereinafter with reference to the accompanying drawings. Note that embodiments to be described hereinafter are examples of when the present invention is implemented, and are some practical embodiments of the arrangements described in the scope of the claims.

### First Embodiment

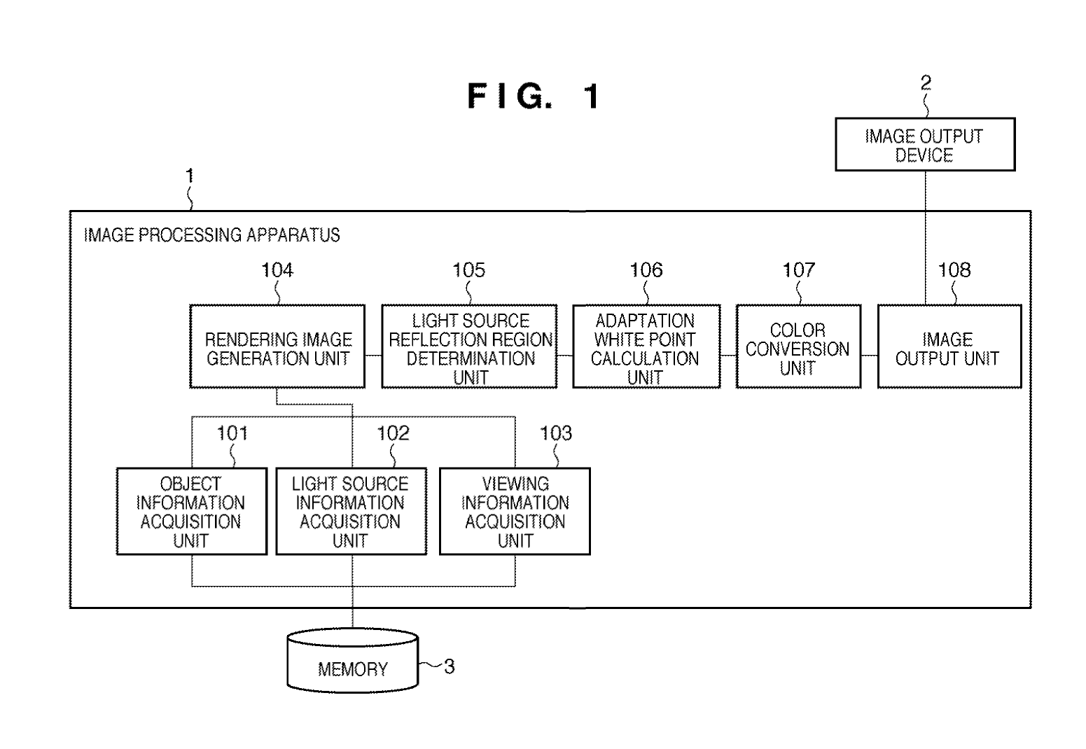

An example of the functional arrangement of an image processing apparatus 1 according to this embodiment and its peripheral devices will be described below with reference to FIG. 1. To the image processing apparatus 1, an image output device 2 and memory 3 are connected. This image output device 2 is a display device such as a CRT or liquid crystal panel in this embodiment. However, the image output device 2 may be other devices such as a printer as long as it can output an image.

The memory 3 stores, for example, information (virtual space information) required to generate an image of a virtual space (an image of a virtual object), and a device profile of the image output device 2. The virtual space information includes information associated with a virtual object to be laid out on the virtual space, information associated with a viewpoint to be laid out on the virtual space, and information associated with a light source to be laid out on the virtual space. Note that various other kinds of information used in respective processes to be described later are also stored in this memory 3 in addition to the aforementioned pieces of information.

An object information acquisition unit 101 reads out information (object information) associated with the virtual object from the memory 3. A light source information acquisition unit 102 reads out information associated with the light source from the memory 3. A viewing information acquisition unit 103 reads out information (viewing information) associated with the viewpoint from the memory 3.

A rendering image generation unit 104 generates an image of the virtual object viewed from the viewpoint as a rendering image using the object information read out by the object information acquisition unit 101, the light source information read out by the light source information acquisition unit 102, and the viewing information read out by the viewing information acquisition unit 103. More specifically, the rendering image generation unit 104 generates a rendering image by projecting light, which comes from the light source, is reflected by the surface of the virtual object, and is received at the position of the viewpoint, onto a projection plane set on the virtual space.

A light source reflection region determination unit 105 determines specular reflection components of respective pixels (respective pixel positions on the projection plane) which form the rendering image, and calculates a ratio=(the number of pixels having nonzero values of specular reflection components)/(the total number of pixels which form the rendering image).

An adaptation white point calculation unit 106 calculates tristimulus values of an adaptation white point of the image output device 2 and those of an adaptation white point of the virtual object using tristimulus values of a white point of the image output device 2, those of a white point of the virtual object, which are determined according to the ratio, and those of a reference white point.

A color conversion unit 107 settles RGB values (device values) of respective pixels which form the rendering image generated by the rendering image generation unit 104 using the adaptation white points calculated by the adaptation white point calculation unit 106. An image output unit 108 outputs the rendering image whose RGB values of the respective pixels are settled by the color conversion unit 107 to the image output device 2.

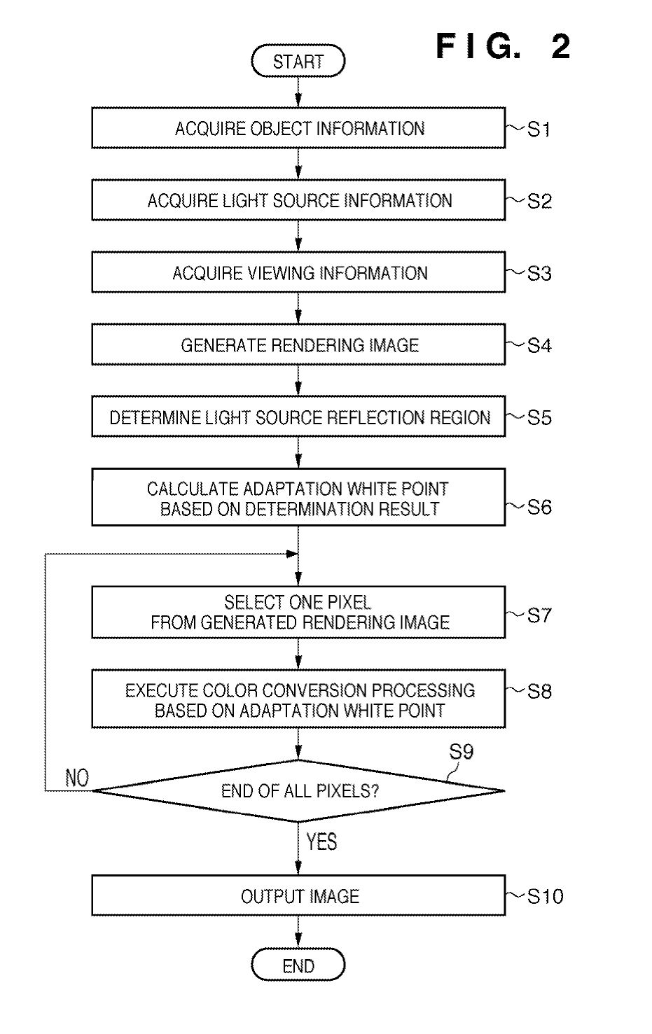

Processing required for the image processing apparatus 1 to generate one rendering image and to output it to the image output device 2 will be described below using FIG. 2 which shows the flowchart of that processing. Hence, when rendering images for a plurality of frames are to be output to the image output device 2, the processing according to the flowchart shown in FIG. 2 is executed for each individual frame.

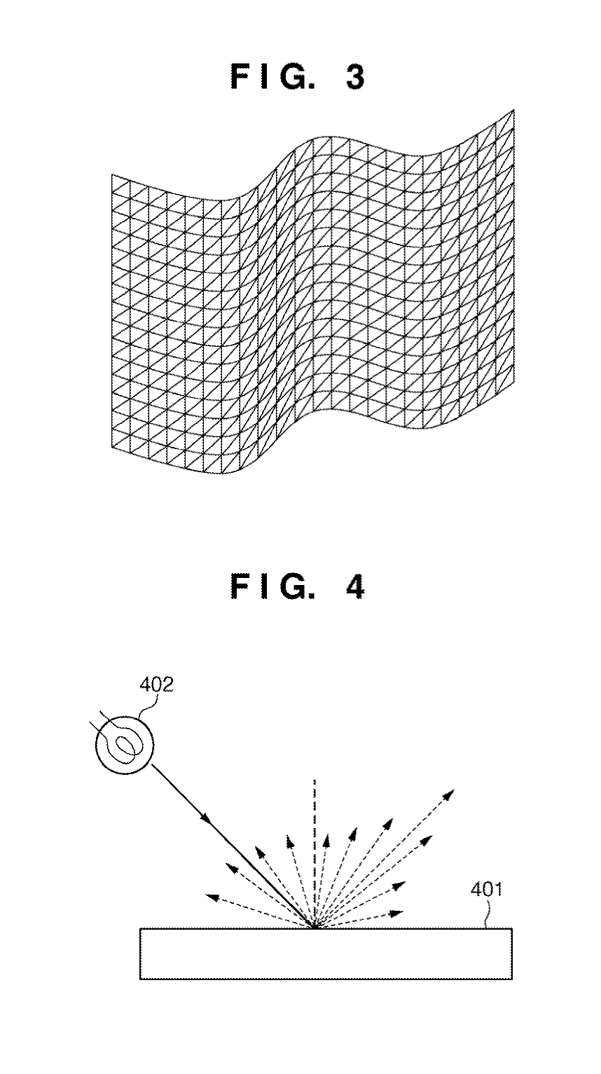

In step S1, the object information acquisition unit 101 acquires the aforementioned object information from the memory 3. In this embodiment, assume that the virtual object is configured by a large number of polygons (planes), as shown in FIG. 3. Hence, this object information includes, for each polygon, color information of the polygon, position information of vertices which configure the polygon, normal vector information of the polygon, and reflection characteristic information of the polygon. Also, the object information includes position and orientation information indicating a layout position and orientation of this virtual object on the virtual space. Such object information is prepared in advance by, for example, CAD software, and is stored in the memory 3.

In this case, assume that the reflectance characteristic information is measurement data of BRDF (Bidirectional Reflectance Distribution Function) characteristics of a polygon, and is measured in advance. The BRDF characteristic is a function unique to a reflection point which represents how much light components are reflected in respective directions when light coming from a light source 402 strikes a certain point on a reflection surface 401 from an arbitrary direction, as shown in FIG. 4.

In step S2, the light source information acquisition unit 102 acquires the aforementioned light source information from the memory 3. This light source information includes information indicating a layout position and orientation of the light source on the virtual space, and spectral radiance information φ(λ) of the light source (λ represents the wavelength of light). Note that the spectral radiance information φ(λ) of the light source represents pieces of radiance information at respective wavelengths λ: 380 to 780 nm. Note that the light source information may include other kinds of information associated with the light source (for example, a color of light emitted by the light source) in addition to the aforementioned pieces of information.

In step S3, the viewing information acquisition unit 103 acquires the aforementioned viewing information from the memory 3. This viewing information includes position and orientation information indicating a position and orientation of the viewpoint upon viewing the virtual space, and viewing parameters such as a focal length and field angle.

In step S4, the rendering image generation unit 104 generates a rendering image of the virtual object using the object information acquired by the object information acquisition unit 101, the light source information acquired by the light source information acquisition unit 102, and the viewing information acquired by the viewing information acquisition unit 103. Note that details of the processing in step S4 will be described later.

In step S5, the light source reflection region determination unit 105 determines specular reflection components of respective pixels (respective pixel positions on the projection plane) which form the rendering image generated in step S4, and calculates the aforementioned ratio. Details of the processing in step S5 will be described later.

In step S6, the adaptation white point calculation unit 106 calculates tristimulus values of an adaptation white point of the image output device 2 and those of an adaptation white point of the virtual object using tristimulus values of a white point of the image output device 2, those of a white point of the virtual object, which are determined according to the ratio, and those of a reference white point.

In step S7, the color conversion unit 107 selects one pixel, which is not selected yet, from the rendering image. In step S8, the color conversion unit 107 settles RGB values of the pixel selected in step S7 using the adaptation white points calculated by the adaptation white point calculation unit 106. If all pixels in the rendering image have been selected in step S7, the process advances to step S10 via step S9; if pixels to be selected still remain in step S7, the process returns to step S7 via step S9. In step S10, the image output unit 108 outputs the rendering image whose RGB values of all the pixels are settled by the color conversion unit 107 to the image output device 2.

<Processing (Step S4) Executed by Rendering Image Generation Unit 104>

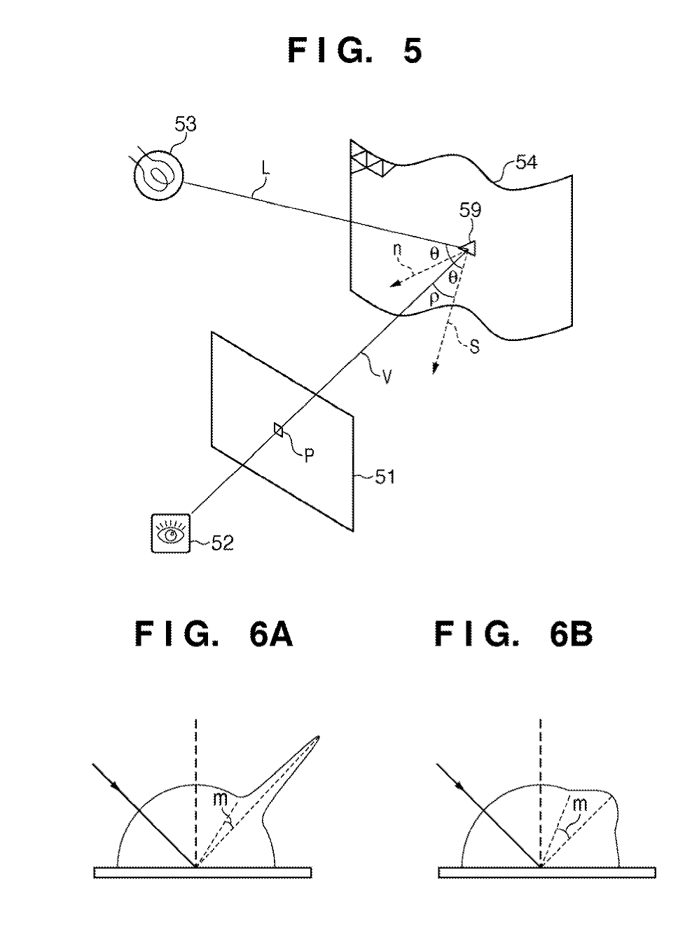

In order to generate a rendering image of the virtual object, a viewpoint 52, projection plane 51, virtual object 54, and light source 53 have to be laid out on the virtual space, as shown in FIG. 5. In this case, as a method of generating a rendering image, a case using a known ray-tracing method will be explained.

In order to decide a pixel value (RGB values) at a pixel position P on the projection plane 51, a line V which passes through the position of the viewpoint 52 and the pixel position P is calculated. When this line V crosses the virtual object 54, it is reflected at the crossing point (intersection). In this way, the processing for, when the line crosses the virtual object, reflecting the line at that crossing point is repeated until the reflected line crosses the light source 53. Then, the pixel value at the pixel position P is decided using pixel values at the respective crossing points. Such processing for calculating a pixel value is executed in association with respective pixel positions on the projection plane 51, thereby deciding pixel values at the respective pixel positions on the projection plane 51.

In this case, the line V crosses the virtual object 54. How ever, the line V actually crosses an arbitrary polygon which configures the virtual object 54. In FIG. 5, the line V crosses a polygon 59. Note that when the size of the polygon 59 is reduced to the utmost limit, this polygon 59 becomes an intersection (intersection position) between the line V and virtual object 54.

Letting θ be an angle (incident angle) a normal vector n to the polygon 59 and a direction vector L of a light ray coming from the light source 53 make, an angle (reflection angle) a direction vector S of specular reflected light of this light ray at the polygon 59 and the normal vector n make is also θ. Also, a direction vector of the line V and the direction vector S of the specular reflected light shifts by an angle (shift angle) ρ.

Thus, in case of FIG. 5, when the rendering image generation unit 104 calculates the line V for the pixel position P, it specifies the polygon 59 where this line V and virtual object 54 cross (first calculation). Then, the rendering image generation unit 104 calculates the shift angle ρ and reflection angle θ in association with the specified polygon 59 (second calculation). As described above, the reflection characteristic information is defined for each polygon. Therefore, according to the aforementioned processing, the shift angle ρ, reflection angle θ, and reflection characteristic information are obtained for the pixel position P. The same applies to other pixel positions.

Next, the rendering image generation unit 104 calculates a luminance spectrum I(λ, θ, ρ) of reflected light at the polygon 59 using the reflection angle θ and shift angle ρ obtained in association with the pixel position P. Then, the rendering image generation unit 104 calculates tristimulus values XYZ on a CIE-XYZ color system (third calculation) by calculating, using this luminance spectrum I(λ, θ, ρ) of the reflected light:

$$X = \frac{1}{k} {\int }_{380}^{780} I ( λ , θ , ρ ) \times x ( λ ) d λ$$

$$Y = \frac{1}{k} {\int }_{380}^{780} I ( λ , θ , ρ ) \times y ( λ ) d λ$$

$$Z = \frac{1}{k} {\int }_{380}^{780} I ( λ , θ , ρ ) \times z ( λ ) d λ$$

$$k = {\int }_{380}^{780} φ ( λ ) \times y ( λ ) d λ$$

where x(λ), y(λ), and z(λ) are color matching functions. Also, k is a quantity proportional to brightness of illuminating light. In this way, the tristimulus values X, Y, and Z expressed by these equations are calculated by multiplying the luminance spectrum I(λ, θ, ρ) of the viewed reflected light by the color matching functions x(λ), y(λ), and z(λ), respectively, and integrating the products within the wavelength range (380 nm to 780 nm) of visible light. According to these equations, the value of a stimulus value Y is normalized and can assume a value ranging from 0 to 1. In this embodiment, the stimulus value Y is expressed using k=1. Therefore, the value of the stimulus value Y depends on the intensity of the spectral radiance φ(λ) of the light source. The tristimulus values XYZ are calculated for the pixel position P.

Thus, the rendering image generation unit 104 executes the aforementioned calculation processes (first to third calculations) for respective pixel positions on the projection plane, thus obtaining a set of the shift angle ρ, reflection angle θ, tristimulus values XYZ, and reflection characteristic information for each of the respective pixel position.

<Processing (Step S5) Executed by Light Source Reflection Region Determination Unit 105>

Upon determining reflection of the light source in the rendering image, the reflection characteristic information and shift angle ρ at each pixel position on the projection plane are used. When the shift angle ρ at a pixel position of interest is larger than a threshold m decided based on the reflection characteristic information at the pixel position of interest, a specular reflection component of a pixel at the pixel position of interest can be assumed as “0”. In this case, this threshold m is decided according to the BRDF characteristics, and a minimum shift angle corresponding to a specular reflection component=0 is used as the threshold m. FIGS. 6A and 6B show examples of different thresholds m in case of different BRDF characteristics. FIG. 6A shows BRDF characteristics with a high image clarity. FIG. 6B shows BRDF characteristics with a low image clarity.

Then, the light source reflection region determination unit 105 determines for respective pixel positions on the projection plane whether or not specular reflection components are assumed to be “0”. The light source reflection region determination unit 105 counts (the number of pixels whose specular reflection components are not assumed to be “0”=the number of pixels for which angles equal to or smaller than the threshold are calculated). The light source reflection region determination unit 105 calculates, as the aforementioned ratio, a value obtained by dividing the counted number of pixels by (the total number of pixels on the projection plane). This ratio naturally assumes a value ranging from 0 to 1.

<Processing (Step S6) Executed by Adaptation White Point Calculation Unit 106>

In this embodiment, a calculation formula used to calculate tristimulus values of partial adaptation white points of the virtual object and image output device 2 from tristimulus values of white points of the virtual object and image output device 2 and those of a reference white point, so as to calculate the tristimulus values of the partial adaptation white points is used as a partial adaptation model. This partial adaptation model will be described in detail later.

Then, in this embodiment, the adaptation white point calculation unit 106 calculates the partial adaptation model by giving the tristimulus values of the white point of the image output device 2, and those of the white point of the virtual object, which are decided according to the value of the ratio, to the partial adaptation model. With this computation, the tristimulus values of the partial adaptation white point of the virtual object and those of the partial adaptation white point of the image output device 2 are calculated.

In this case, the tristimulus values of the white point of the image output device 2 are included in the device profile of the image output device 2, which is held in the memory 3. Also, the tristimulus values of the reference white point use a point on a blackbody radiation locus having a color temperature=8500K, and are also stored as information in the memory 3. Note that tristimulus values of other white points such as equi-energy white may be used as those of the reference white point.

In this case, as described above, the adaptation white point calculation unit 106 decides the tristimulus values of the white point of the virtual object to be given to the partial adaptation model according to the ratio calculated by the light source reflection region determination unit 105. This decision method will be described below.

When the ratio is “0” (or when it is sufficiently close to “0”), the adaptation white point calculation unit 106 gives tristimulus values calculated by multiplying a perfect reflecting diffuser by the spectral radiance value φ(λ) of the light source to the partial adaptation model as those of the white point of the virtual object. Note that other tristimulus values may be given to the partial adaptation model when the ratio is “0”. For example, by referring to diffuse reflection components at respective pixel positions on the projection plane, tristimulus values at a pixel position with a highest luminance level may be used as those of the white point of the virtual object.

When the ratio is “1” (or when it is sufficiently close to “1”), the adaptation white point calculation unit 106 sets a luminance value Y of a specular reflection component having a highest intensity in the rendering image as that of the white point of the virtual image. Assume that the chromaticities of the white point of the virtual object are the same as those of the tristimulus values of the perfect reflecting diffuser.

When the ratio assumes a value ranging from “0” to “1”, the adaptation white point calculation unit 106 combines the tristimulus values described as those to be given to the partial adaptation model when the ratio=0 and the tristimulus values described as those to be given to the partial adaptation model when the ratio=1 according to the value of the ratio. For example, assume that the ratio is r (0<r<1). In this case, the adaptation white point calculation unit 106 calculates a result of adding tristimulus values obtained by multiplying the tristimulus values described as those to be given to the partial adaptation model when the ratio=0 by (1−r), and tristimulus values obtained by multiplying the tristimulus values described as those to be given to the partial adaptation model when the ratio=1 by r. Then, the adaptation white point calculation unit 106 gives this addition result (combined result) to the partial adaptation model as the tristimulus values of the white point of the virtual object.

In this manner, the adaptation white point calculation unit 106 can calculate the tristimulus values of the partial adaptation white point of the virtual object and those of the partial adaptation white point of the image output device 2 in consideration of the white point of the image output device 2, the spectral radiance of the light source, and the BRDF characteristics of the virtual object.

<Processing (Step S8) Executed by Color Conversion Unit 107>

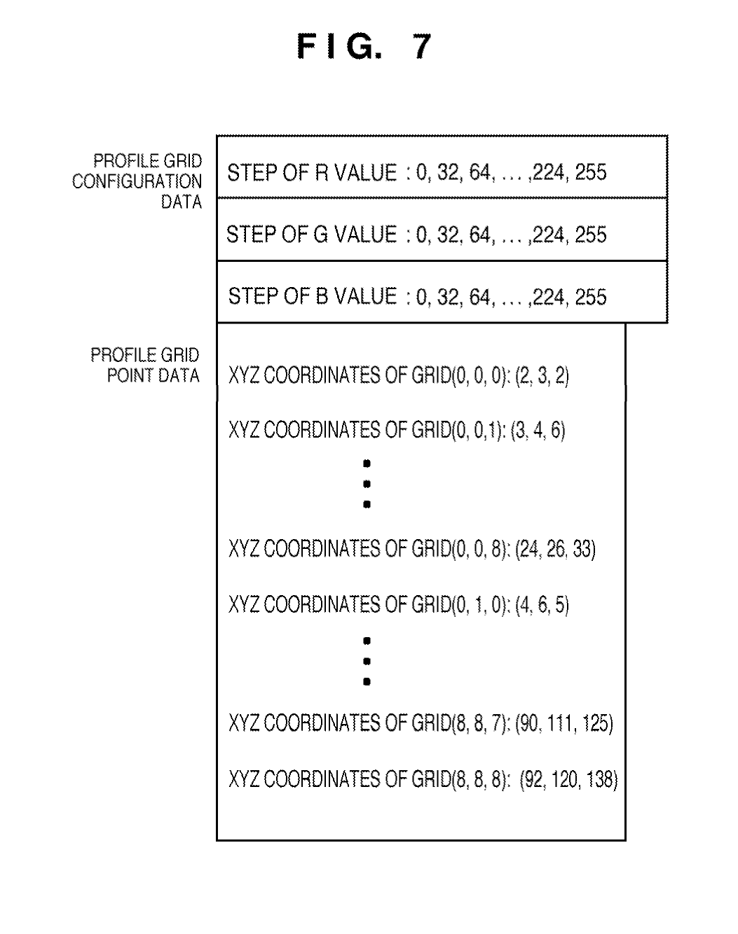

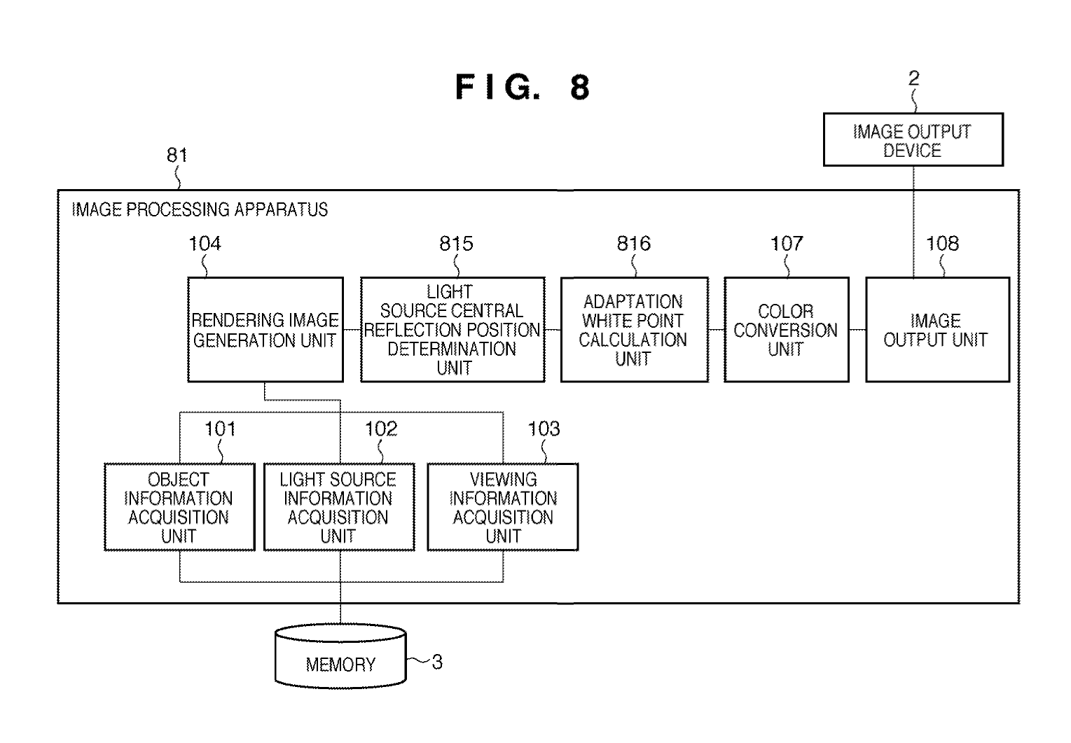

The color conversion unit 107 reads out tristimulus values XYZ of respective grid points described in the device profile of the image output device 2, which profile is stored in the memory 3. FIG. 7 shows an example of the device profile of the image output device 2. As shown in FIG. 7, the device profile describes tristimulus values XYZ corresponding to respective grid points on an RGB color space.

Then, the color conversion unit 107 applies CIECAM02 chromatic adaptation conversion to the tristimulus values XYZ of the respective grid points read out from the device profile using the “tristimulus values of the partial adaptation white point of the image output device 2” calculated in step S6. Thus, the color conversion unit 107 converts the tristimulus values XYZ of the respective grid points to JCh values. Then, the color conversion unit 107 specifies outermost grid points with reference to the JCh values of the grid points, thus calculating a color reproduction range of the image output device 2.

Next, the color conversion unit 107 applies CIECAM02 chromatic adaptation conversion to the tristimulus values XYZ obtained for the respective pixel positions on the projection plane using the “tristimulus values of the partial adaptation white point of the virtual object” calculated in step S6. Thus, the color conversion unit 107 converts the tristimulus values XYZ obtained for the respective pixel positions on the projection plane into JCh values. Note that CIECAM02 is used in chromatic adaptation conversion in this embodiment. However, other chromatic adaptation conversion methods such as a Von Kries chromatic adaptation formula may be used.

The color conversion unit 107 executes color compression (colorimetric gamut compression) of the JCh values calculated for respective pixel positions on the projection plane to fall within the color reproduction range. The gamut compression processing is executed to convert colors outside the color reproduction range to those within the color reproduction range. The colorimetric gamut compression is a method of keeping colors within the color reproduction range intact, and compressing colors outside the color reproduction range to closest points in the color reproduction range. Various color compression methods are available, and color compression methods other than colorimetric gamut compression may be used.

The color conversion unit 107 then applies CIECAM02 inverse color adaptation conversion to the color-compressed JCh values using the “tristimulus values of the partial adaptation white point of the virtual object” calculated in step S6. Thus, the JCh values can be converted into tristimulus values XYZ for respective pixel positions on the projection plane. Next, the color conversion unit 107 converts these tristimulus values XYZ into RGB values using “correspondence information between tristimulus values XYZ and RGB values” described in the device profile of the image output device 2. Thus, the tristimulus values XYZ can be converted into RGB values for respective pixel positions on the projection plane. When tristimulus values XYZ which are not described in the device profile are to be converted into RGB values, RGB values are calculated from tristimulus values XYZ of grid points around the tristimulus values XYZ of interest using interpolation processing such as tetrahedral interpolation.

With the aforementioned processing, since RGB values for respective pixel positions on the projection plane can be settled, a rendering image configured by pixels having RGB values can be formed on the projection plane.

<Adaptation Model>

FIG. 10 is a conceptual graph of the relationship among white points. A human visual system cannot completely correct the color of a light source even at the time of viewing of a monitor and at the time of viewing of the virtual object. Therefore, incomplete adaptation has to be corrected. In order to accurately correct incomplete adaptation, white, which is perceived by the human visual system to be whitest (indicated by a Δ mark in FIG. 10), should be used as reference white. Hence, as described above, a point on a blackbody radiation locus having a color temperature=8500K is used as the reference white point. This is based on experimental results of white which is perceived best by subjects when white is displayed on a monitor and the color temperature of white is changed. Of course, the reference white is not limited to this white point, and another white point, for example, a white point on a daylight locus, which has a color temperature higher than equi-energy white, may be set.

In calculations using the adaptation model, chromaticities u_{Wm} and v_{Wm} of the white point of the image output device 2 (to be referred to as a monitor white point hereinafter) and chromaticities u_{Wp} and v_{Wp} of the white point of the virtual object (to be referred to as a virtual object white point hereinafter) are calculated using:

u_{Wi}=4·X_{Wi}/(X_{Wi}+15·Y_{Wi}+·Z_{Wi})

v_{Wi}=6·Y_{Wi}/(X_{Wi}+15·Y_{Wi}+·Z_{Wi}) (1)

where i=m, p,

X_{Wm}, Y_{Wm}, and Z_{Wm} are tristimulus values of the monitor white point, and

X_{Wp}, Y_{Wp}, and Z_{Wp} are tristimulus values of the virtual object white point.

Next, a color temperature T_{Wm} of the monitor white point corresponding to the chromaticities of the monitor white point, and a color temperature T_{Wp} of the virtual object white point corresponding to the chromaticities of the virtual object white point are acquired from, for example, a chromaticity—color temperature table stored in the memory 3.

Then, a color temperature T′_{Wm} of the monitor white point and a color temperature T′_{Wp} of the virtual object white point, which are used for incomplete adaptation correction, are calculated using:

1/T′_{Wm}={k_{inc}_{_{—}}ₘ·1/T_{Wm}}+{(1−k_{inc}_{_{—}}ₘ)·1/T_{Wr}}

1/T′_{Wp}={k_{inc}_{_{—}}ₚ·1/T_{Wp}}+{(1−k_{inc}_{_{—}}ₚ)·1/T_{Wr}} (2)

where k_{inc}_{_{—}}ᵢ is an incomplete adaptation coefficient, and

0≦k_{inc}_{_{—}}ᵢ<1.

Note that the color temperature T_{Wr} of the reference white point is 8500K, as described earlier. Note also that the incomplete adaptation coefficient uses a value set by the user, but it can be automatically calculated using, for example, a function. The reason why the reciprocal of the color temperature is used is that the color temperature difference does not correspond to a color difference that one can perceive, but the reciprocal of the color temperature is nearly equal to human perception.

Using the white points having the color temperatures calculated using equations (2), incomplete adaptation can be accurately corrected, and color appearance upon viewing the image output device 2 or virtual object solely can be accurately predicted. However, when the user wants to simultaneously view the image output device 2 and virtual object, his or her adaptation state is different from that upon sole viewing. In this case, when the user views the image output device 2, he or she may be influenced by the virtual object white point. When the user views the virtual object, he or she may be influenced by the monitor white point.

Hence, in consideration of partial adaptation, a color temperature T″_{Wm} of the monitor white point and a color temperature T″_{Wp} of the virtual object white point, which are used for partial adaptation correction, are calculated using:

1/T″_{Wm}=(Km·L*ₘ·1/T′_{Wm}−Km′·L*ₚ·1/T′_{Wp})/(Km·L*ₘ+Km′·L*ₚ)

1/T″_{Wp}=(Kp·L*ₚ·1/T′_{Wp}−Kp′·L*ₘ·1/T′_{Wm})/(Kp·L*ₚ+Kp′·L*ₘ) (3)

where Ki=kₘᵢₓ_{_{—}}ᵢ is a partial adaptation coefficient,

Ki′=1−Ki,

0≦Ki≦1, and

L*ᵢ is a weighting coefficient based on the luminance level of the white point.

Note that the partial adaptation coefficient uses a value set by the user, but it can be automatically calculated using, for example, a function. Also, based on a concept that one adapts more to a white point having a higher luminance level, the weighting coefficient L*₁ is calculated using:

When Y_{Wm}≦Y_{Wp}, L*ₘ=116.0×(Y_{Wm}/Y_{Wp})^{1/3}−16.0 else, L*ₘ=100

When Y_{Wp}≦Y_{Wm}, L*ₘ=116.0×(Y_{Wp}/Y_{Wm})^{1/3}−16.0 else, L*ₚ=100 (4)

Next, using the aforementioned chromaticity—color temperature table, chromaticities u″_{Wm} and v″_{Wm} corresponding to the color temperature of the monitor white point for partial adaptation correction, and chromaticities u″_{Wp} and v″_{Wp} corresponding to the color temperature of the virtual object white point for partial adaptation correction are inversely calculated. Then, tristimulus values X″_{Wm}, Y″_{Wm}, and Z″_{Wm} of the monitor white point for partial adaptation correction are calculated by:

When Y_{Wm}≦Y_{Wp}, Y″_{Wm}={(L*″_{Wm}+16.0)/116.0}³·Y_{Wp} else, Y″_{Wm}=Y_{Wm}

X″_{Wm}=(3.0/2.0)·(u″_{Wm}/v″_{Wm})·Y″_{Wm} (5)

Z″_{Wm}=(4.0·X″_{Wm}/u″_{Wm}−X″_{Wm}−15.0·Y″_{Wm})/3.0 for L*″_{Wm}=L*ₘ·kₘ+100.0(1−kₘ)

Also, tristimulus values X″_{Wp}, Y″_{Wp}, and Z″_{Wp} of the virtual object white point for partial adaptation correction are calculated by:

When Y_{Wp}≦Y_{Wm}, Y″_{Wp}={(L*″_{Wp}+16.0)/116.0}³·Y_{Wm} else, Y″_{Wp}=Y_{Wp}

X″_{Wp}=(3.0/2.0)·(u″_{Wp}/v″_{Wp})·Y″_{Wp} (6)

Z″_{Wp}=(4.0·X″_{Wp}/u″_{Wp}−X″_{Wp}−15.0·Y″_{Wp})/3.0 for L*″_{Wp}=L*ₚ·kₚ+100.0(1−kₚ)

As described above, according to this embodiment, since color conversion is performed using optimal adaptation white points according to the area of a light source reflection region, actual appearance of an object can be reproduced more faithfully.

### Second Embodiment

In the first embodiment, the adaptation white points are calculated according to the ratio of (the number of pixels whose specular reflection components cannot be assumed to be zero) to (the total number of pixels on the projection plane), that is, the area of the light source reflection region. In this embodiment, the adaptation white points are calculated according to distances from reflection of a central point of the light source for respective pixel positions on a rendering image.

An example of the functional arrangement of an image processing apparatus 81 according to this embodiment and its peripheral devices will be described with reference to FIG. 8. The same reference numerals in FIG. 8 denote the same parts as in FIG. 1, and a description thereof will not be repeated.

A light source central reflection position determination unit 815 determines distances from a reflection position of a central point of the light source for respective pixel positions within a region required to form a rendering image on the projection plane (rendering image region). An adaptation white point calculation unit 816 calculates adaptation white points for respective pixels within the rendering image region according to the determination result of the light source central reflection position determination unit 815.

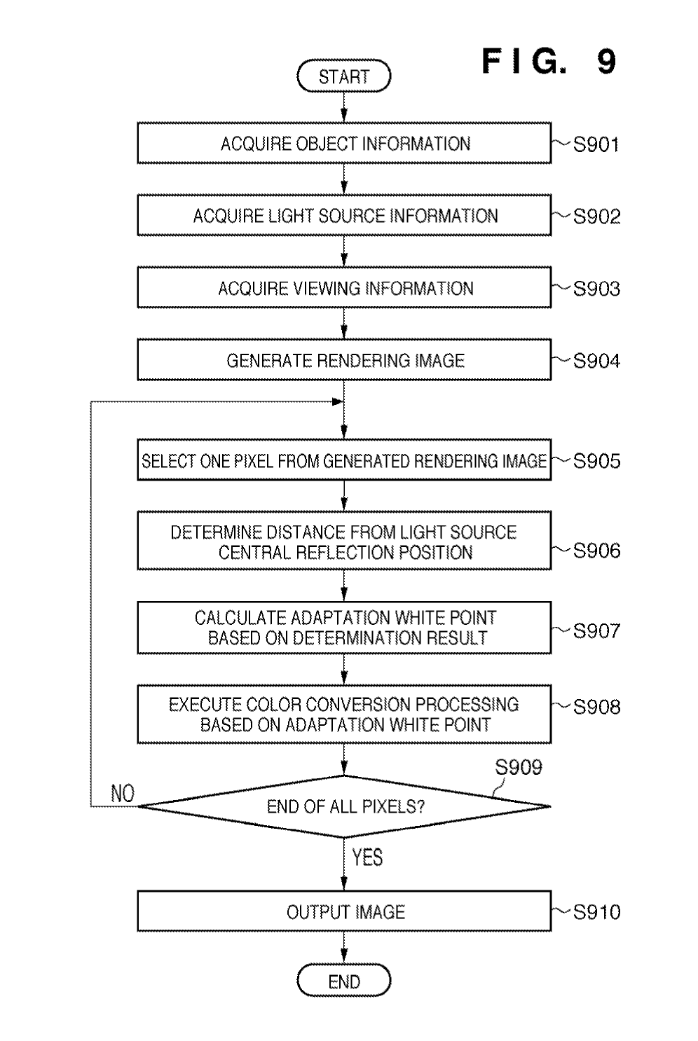

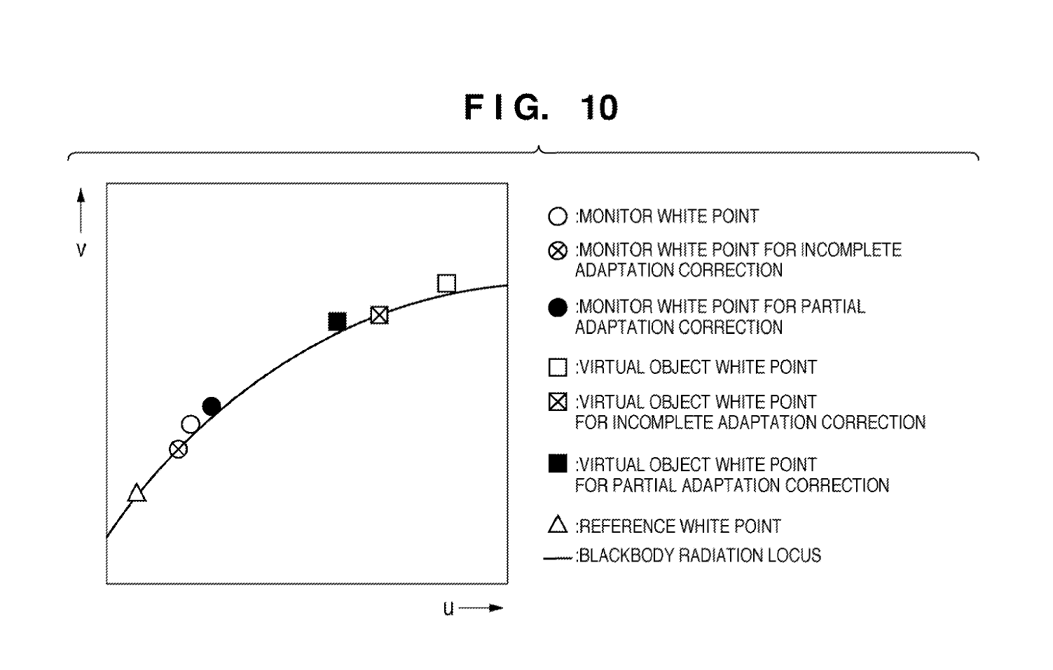

Processing required for the image processing apparatus 81 to generate a rendering image for one frame will be described below using FIG. 9 which shows the flowchart of that processing. Thus, when rendering images for a plurality of frames are to be output to an image output device 2, the processing according to the flowchart shown in FIG. 8 is executed for each individual frame.

Since processes in steps S901 to S904 are the same as those in steps S1 to S4 described above, a description thereof will not be repeated. Note that steps S901 to S904 are the same as steps S1 to S4, but processing for calculating information which is not required in the following processing may be skipped.

In step S905, the light source central reflection position determination unit 815 selects one pixel, which is not selected yet, from a pixel group in the rendering image region. In step S906, the light source central reflection position determination unit 815 calculates a reflection position of the central point of the light source on the projection plane, and calculates a distance from the calculated position to the position (selected pixel position) of the pixel (selected pixel) selected in step S905. Details of the processing in this step will be described later.

In step S907, the adaptation white point calculation unit 816 executes the following processing. The adaptation white point calculation unit 816 calculates, based on the distance calculated in step S906 for the selected pixel, tristimulus values of an adaptation white point of the image output device 2 and those of an adaptation white point of the selected pixel using tristimulus values of a white point of the image output device 2, those of a white point of a virtual object, and those of a reference white point.

In step S908, a color conversion unit 107 settles RGB values of the selected pixel using the adaptation white points calculated by the adaptation white point calculation unit 816. The processing in step S908 is the same as that in step S8 described above, except that color conversion processing is executed for each pixel.

If all pixels in the rendering image region have been selected in step S905, the process advances to step S910 via step S909; if pixels to be selected still remain in step S905, the process returns to step S905 via step S909. In step S910, an image output unit 108 outputs a rendering image whose RGB values of all pixels are settled by the color conversion unit 107 to the image output device 2.

<Processing (Step S906) Executed by Light Source Central Reflection Position Determination Unit 815>

The light source central reflection position determination unit 815 specifies a pixel position C where the directions of a direction vector S of specular reflected light to a direction vector L of a light ray coming from the central point of the light source and a line V from a viewpoint 52 are parallel to each other (a shift angle ρ is closest to “0”) from respective pixel positions on the projection plane. That is, the unit 815 specifies this pixel position C as a “light source central reflection position”. In this specifying processing of the pixel position C, the size of the projection plane is set to be sufficiently larger than that of the rendering image.

Next, the light source central reflection position determination unit 815 calculates a distance between the pixel position C and the position of the selected pixel. The light source central reflection position determination unit 815 then calculates a value of a fraction having this calculated distance as a numerator and a diagonal distance of the rendering image region as a denominator. Note that the denominator is not limited to this.

When the calculated value of the fraction is larger than “1”, the light source central reflection position determination unit 815 outputs “0” as a determination result. When the calculated value of the fraction is “1”, the unit 815 outputs “0” as a determination result. When the calculated value of the fraction is “0”, the unit 815 outputs “1” as a determination result. When the calculated value of the fraction is r (0<r<1), the unit 815 outputs (1−r) as a determination result.

<Processing (Step S907) Executed by Adaptation White Point Calculation Unit 816>

In the first embodiment, since the determination result is uniquely decided for the rendering image, partial adaptation white points are fixed. However, in this embodiment, since determination results are different for respective pixels of the rendering image, the partial adaptation white points are also different for respective pixels.

The tristimulus values of the white point of the virtual object to be input to a partial adaptation model are decided as follows. When the determination result of the light source central reflection position determination unit 815 is “1”, a luminance value Y of the specular reflected light S at the pixel position C is set as a luminance value of the white point of the virtual object. Also, chromaticities of the white point of the virtual object are set to be the same as those of the tristimulus values of the perfect reflecting diffuser.

When the determination result of the light source central reflection position determination unit 815 is “0”, tristimulus values calculated by multiplying the perfect reflecting diffuser by a spectral radiance φ(λ) of the light source are given to the partial adaptation model as those of the white point of the selected pixel.

When the determination result of the light source central reflection position determination unit 815 assumes a value ranging from “0” to “1”, the tristimulus values when the determination result is “0” and those when the determination result is “1” are combined according to the value of the determination result, as in the first embodiment. For example, assume that the determination result is f (0<f<1). In this case, a result of adding tristimulus values obtained by multiplying the tristimulus values when the determination result is “0” by (1−f) and those obtained by multiplying the tristimulus values when the determination result is “1” by f is calculated. Then, the adaptation white point calculation unit 816 gives this addition result (combined result) to the partial adaptation model as the tristimulus values of the white point of the selected pixel.

As described above, according to this embodiment, since color conversion is executed using optimal adaptation white points according to the distances from the reflection position of the light source center, actual appearance of an object can be reproduced more faithfully.

### Third Embodiment

In the description of the first embodiment, all the units which configure the image processing apparatus 1 shown in FIG. 1 are implemented by hardware. Also, in the description of the second embodiment, all the units which configure the image processing apparatus 81 shown in FIG. 8 are implemented by hardware. However, some or all of these units may be implemented by software (computer programs).

When the units which configure the image processing apparatus 1 or 81 shown in FIG. 1 or 8 are implemented by software, this software is executed by a computer which includes an execution unit such as a CPU, a RAM, a ROM, and a memory such as a hard disk. In this case, this software is stored in that memory, and is executed by that execution unit. Of course, the arrangement of the computer which executes this software is not particularly limited.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-118769 filed May 24, 2010 which is hereby incorporated by reference herein in its entirety.

1. An image processing apparatus comprising:
a first acquisition unit configured to acquire information of an object and information of a light source, which are laid out on a virtual space;
a second acquisition unit configured to acquire a viewing condition required to view the object;
a first decision unit configured to decide a state of reflection of the light source on the object upon viewing the object based on the viewing condition; and
a second decision unit configured to decide an adaptation white point upon displaying the object by an image output unit, based on the state of reflection.

2. The apparatus according to claim 1, wherein the first decision unit comprises:
a first calculation unit configured to calculate, letting a rendering image region be a region required to form a rendering image of the object on a projection plane laid out on the virtual space, a line which passes through a pixel position of interest in the rendering image region and a position of a viewpoint set on the virtual space, and to calculate an intersection position between the calculated line and the object;
a second calculation unit configured to calculate an angle a direction vector of reflected light which comes from the light source and is reflected at the intersection position, and a direction vector of the line make;
a third calculation unit configured to calculate a luminance spectrum of the reflected light, and to calculate tristimulus values from the calculated luminance spectrum;
a unit configured to calculate the angles and the tristimulus values for respective pixel positions on the projection plane by executing calculation processes by said first calculation unit, said second calculation unit, and said third calculation unit for the respective pixel positions on the projection plane; and
a unit configured to specify a pixel position where the angle is closest to “0”, to calculate distances between the specified pixel position and respective pixel positions in the rendering image region, and to calculate ratios of the calculated distances to a diagonal distance of the rendering image region.

3. The apparatus according to claim 2, wherein said second decision unit executes processing for calculating tristimulus values of a partial adaptation white point of a selected pixel position, which is selected from the rendering image region, and tristimulus values of a partial adaptation white point of the image output unit by giving tristimulus values of a white point of the image output unit included in a device profile of the image output unit and tristimulus values of a white point of the selected pixel position decided according to a value of the ratio to a calculation formula required to calculate the tristimulus values of the partial adaptation white point of the selected pixel position and the tristimulus values of the partial adaptation white point of the image output unit from tristimulus values of the white point of the selected pixel position, tristimulus values of the white point of the image output unit, and tristimulus values of a reference white point, and calculating the calculation formula,
when the ratio is “0”, said second decision unit gives tristimulus values calculated by multiplying tristimulus values of a perfect reflecting diffuser by a spectral radiance value of the light source to the calculation formula as the tristimulus values of the white point of the selected pixel position,
when the ratio is “1”, said second decision unit gives tristimulus values including a luminance value of a specular reflection component at the selected pixel position and chromaticities which are the same as chromaticities of the tristimulus values of the perfect reflecting diffuser to the calculation formula as the tristimulus values of the white point of the selected pixel position, and
when the ratio assumes a value ranging from 0 to 1, said second decision unit gives tristimulus values obtained by combining the tristimulus values when the ratio is “0” and the tristimulus values when the ratio is “1” according to the ratio to the calculation formula as the tristimulus values of the white point of the selected pixel position.

4. An image processing method comprising:
a first acquisition step of acquiring information of an object and information of a light source, which are laid out on a virtual space;
a second acquisition step of acquiring a viewing condition required to view the object;
a first decision step of deciding a state of reflection of the light source on the object upon viewing the object based on the viewing condition; and
a second decision step of deciding an adaptation white point upon displaying the object by an image output unit, based on the state of reflection.
